(19) United States
(12) Patent Application Publication
(10) Pub. No.: US 2009/0313686 A1
(43) Pub. Date: Dec. 17, 2009

(54) Method of tracking a network-enabled device

(76) Inventors: W. David Wilson, Cincinnati, OH (US); Robert E. Banziger, Batavia, OH (US)

Correspondence Address: TAFT, STETTINIUS & HOLLISTER LLP, SUITE 1800, 425 WALNUT STREET, CINCINNATI, OH, 45202-3957, US

(21) Appl. No.: 12/456,510

(22) Filed: Jun. 17, 2009

Related U.S. Application Data
(60) Provisional application No. 61/132,227, filed on Jun. 17, 2008.

(51) Int. Cl. G06F 21/20; G06F 17/30; G06F 15/16; H04L 9/32

(52) U.S. Cl. 726/7; 707/3; 707/E17.108; 709/227

(57) ABSTRACT

Methods of tracking a network-enabled device are provided. One method may include establishing a link between the network-enabled device and a predetermined network portal via a tracking tool operating on the network-enabled device, transmitting identifying indicia to database server(s) operably coupled to the predetermined network portal, comparing the identifying indicia to predetermined information stored on the database server(s) to determine if the identifying indicia matches the predetermined information, and upon determining that the identifying indicia matches the predetermined information, storing the identifying indicia in a logging database stored on the database server(s).

### CROSS-REFERENCE TO RELATED APPLICATIONS

This application claims the benefit of U.S. Provisional Application Ser. No. 61/132,227, entitled “SYSTEM AND METHOD TO RECOVER LOST, MISSING OR STOLEN WEB READY DEVICES AND DATA,” filed on Jun. 17, 2008, the disclosure of which is incorporated herein by reference.

### BACKGROUND

As electronics such as portable electronics and computing devices become more prevalent in everyday life, theft or loss of such electronics will likely also increase. Further, with the loss or theft of such electronics, valuable data (such as personally identifiable information and/or company trade secrets, for example) stored on the electronics may be misused. Misuse of data may include and/or lead to identity theft, which has been rapidly increasing in recent years.

Therefore, society may benefit from a mechanism of recovering these lost or stolen electronics. Further, it may be beneficial to provide a mechanism to determine the identity of those responsible for the theft, misuse or dissemination of data stored on the electronics.

### BRIEF DESCRIPTION OF THE DRAWINGS

FIG. 1 is a diagram depicting an exemplary embodiment of the present invention.

FIG. 2 is a flow diagram depicting another exemplary embodiment of the present invention.

FIG. 3 is a flow diagram depicting yet another exemplary embodiment of the present invention.

FIG. 4 is a diagram depicting another exemplary embodiment of the present invention.

FIG. 5 is a diagram depicting yet another exemplary embodiment of the present invention.

FIG. 6 is a diagram depicting another exemplary embodiment of the present invention.

FIG. 7 is a diagram depicting yet another exemplary embodiment of the present invention.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, may be arranged, substituted, combined, and designed in a wide variety of different configurations, all of which are explicitly contemplated and make part of this disclosure.

This disclosure is generally drawn to methods and systems related to tracking and/or locating a network-enabled device. Examples of such devices may include a computing device, a desktop computer, a notebook computer, a netbook computer, a routing device, a firewall device, a cellular phone device, an audio device, a video device, a gaming device, a multimedia device, a telecommunications device and/or another network-enabled device. Exemplary networks may include Internet, an intranet, an extranet, a local area network, a metropolitan area network, a wide area network, a global area network, a wired network, a wireless network and/or a cellular network, among others.

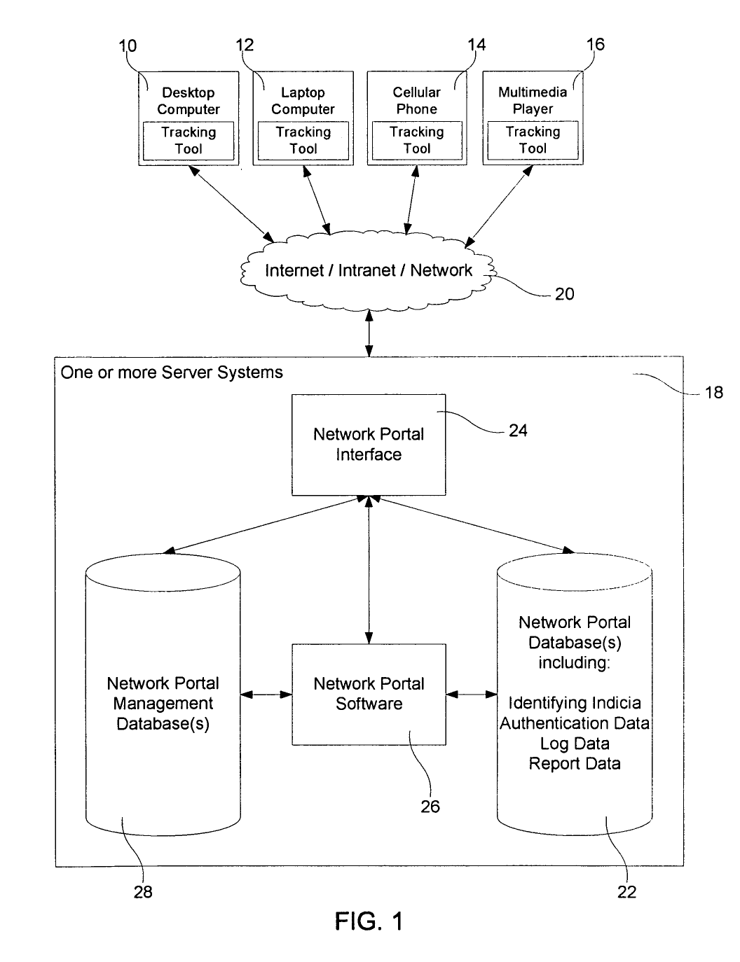

In an exemplary embodiment, the present disclosure contemplates that a network-enabled device may be configured to communicate with one or more servers via the network. For example, as depicted in FIG. 1, a network-enabled device 10, 12, 14, 16 may be in communication with one or more servers 18 via the network 20 (such as the Internet). Each network-enabled device 10, 12, 14, 16 may include a tracking tool operating thereon. The one or more servers 18 may include a network portal including an interface 24, software 26 and management database(s) 28. Further, the one or more servers 18 may include database(s) 22 having identifying indicia, authentication data, log data, report data and/or other similar data.

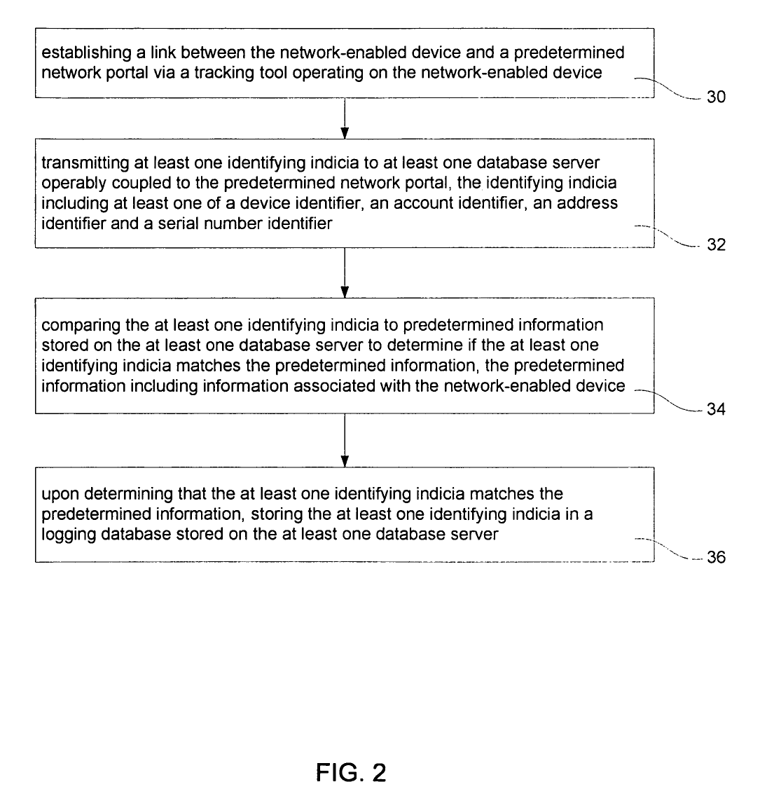

In an exemplary embodiment (as shown in FIG. 2), a method of tracking a network-enabled device is provided. This method may include establishing 30 a link between the network-enabled device and a predetermined network portal via a tracking tool operating on the network-enabled device, transmitting 32 identifying indicia to database server(s) operably coupled to the predetermined network portal, comparing 34 the identifying indicia to predetermined information stored on the database server(s) to determine if the identifying indicia matches the predetermined information, and upon determining that the identifying indicia matches the predetermined information, storing 36 the identifying indicia in a logging database stored on the database server(s). If the identifying indicia does not match the predetermined information, the identifying indicia may still be stored in the logging database (or other related database) for security reasons. In this embodiment, the identifying indicia may include a device identifier, an account identifier, an address identifier and/or a serial number identifier. Further, the predetermined information may include other information associated with the network-enabled device, such as operating systems installed on the device, applications installed on the device and other similar information.

In another embodiment, the method may also include identifying a physical location of the network-enabled device based, at least in part, on the identifying indicia stored in the logging database. In another embodiment, the method may include providing the identifying indicia stored in the logging database to a law enforcement agency for purposes of tracking and/or locating the network-enabled device (or the possessor thereof). The law enforcement agency (whether it be a local, municipal, state, federal and/or international agency) may use the identifying indicia to track and/or to locate network-enabled device and, perhaps, the person in possession of the network-enabled device.

In one embodiment, the address identifier may include an Internet Protocol address. In another embodiment, the predetermined network portal may include a website, a webpage, a database, a widget and/or a web application. In another embodiment, the storing operation may further include storing a time and/or a date associated with the transmitting operation.

In another embodiment, the tracking tool may be implemented in the network-enabled device's BIOS, read-only memory (ROM), EPROM, EEPROM, flash ROM, operating system, firmware and/or software. Further, the tracking tool may be installed on the network-enabled device by a manufacturer, a distributor, a reseller, a retailer, an owner and/or a user of the network-enabled device.

In yet another embodiment, the establishing a link operation may occur automatically upon providing power to the network-enabled device. In another embodiment, the establishing a link operation may occur automatically upon establishing a network connection by the network-enabled device.

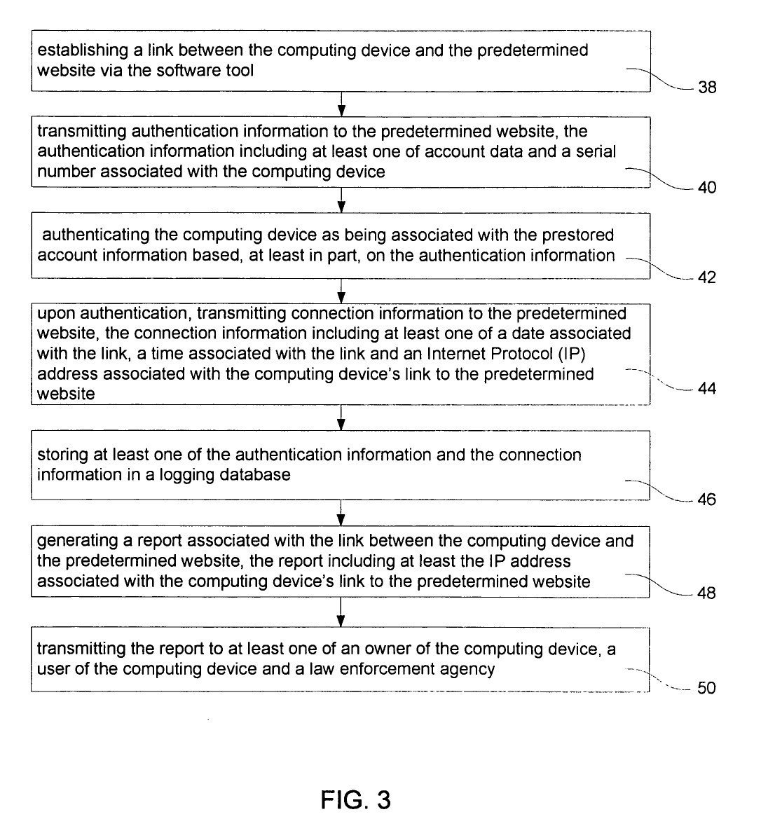

In another exemplary embodiment (as shown in FIG. 3), a method of tracking a computing device is provided, where the computing device is operably coupled to the Internet. The computing device includes a software tool configured to transmit data to a predetermined website having prestored account information associated with the computing device. This method may include establishing 38 a link between the computing device and the predetermined website via the software tool, transmitting 40 authentication information to the predetermined website, authenticating 42 the computing device as being associated with the prestored account information based, at least in part, on the authentication information, and, upon authentication, transmitting 44 connection information to the predetermined website. The method may further include storing 46 the authentication information and/or the connection information in a logging database, generating 48 a report associated with the link between the computing device and the predetermined website, and transmitting 50 the report to an owner of the computing device, a user of the computing device and/or a law enforcement agency. In this embodiment, the authentication information may include account data and/or a serial number associated with the computing device. The report may include the IP address associated with the computing device's link to the predetermined website.

In one embodiment, the transmitting operation 50 may occur automatically after the generating 48 operation, and/or upon request of the owner, user and/or law enforcement agency.

In one embodiment, the method may also include identifying a physical location of the computing device based, at least in part, on the IP address stored in the logging database. In another embodiment, the report may further include the authentication information and/or the connection information.

In another embodiment, a sequence of links may be established between the computing device and the predetermined website, where each link may be established at a unique instance in time. In such an embodiment, the transmitting authentication information, authenticating, transmitting connection information and storing operations may be repeated for each of the plurality of links. In another embodiment, the report may further include the authentication information and/or the connection information associated with each link.

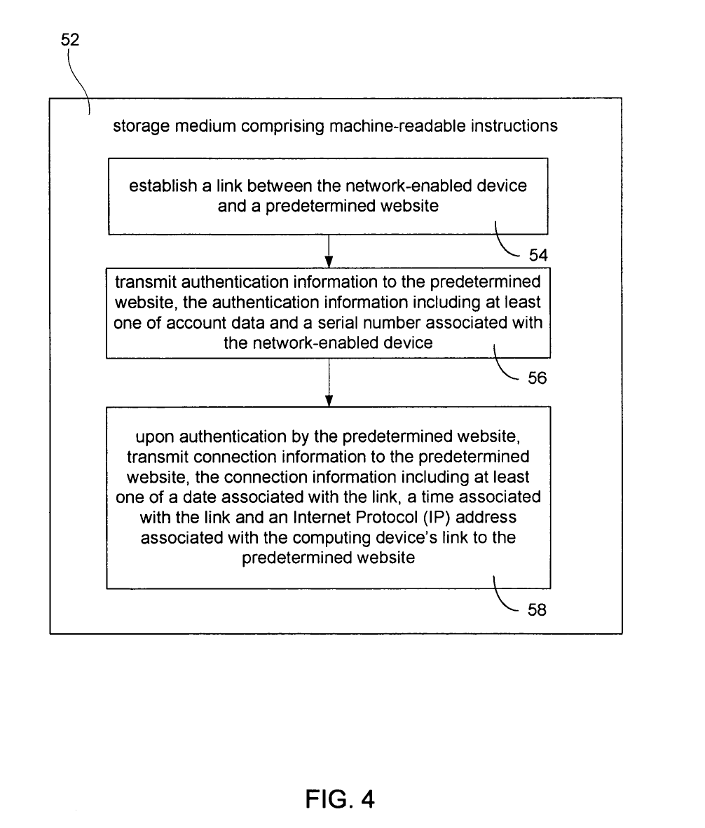

In another exemplary embodiment (as shown in FIG. 4), a storage medium 52 comprising machine-readable instructions stored thereon is provided. The instructions, when executed by one or more processing units, are configured to operatively enable a network-enabled device to perform operations. The instructions may include establish 54 a link between the network-enabled device and a predetermined website, transmit 56 authentication information to the predetermined website (where the authentication information may include account data and/or a serial number associated with the network-enabled device), and upon authentication by the predetermined website, transmit 58 connection information to the predetermined website. In this embodiment, the connection information may include a date associated with the link, a time associated with the link and/or an Internet Protocol (IP) address associated with the computing device's link to the predetermined website.

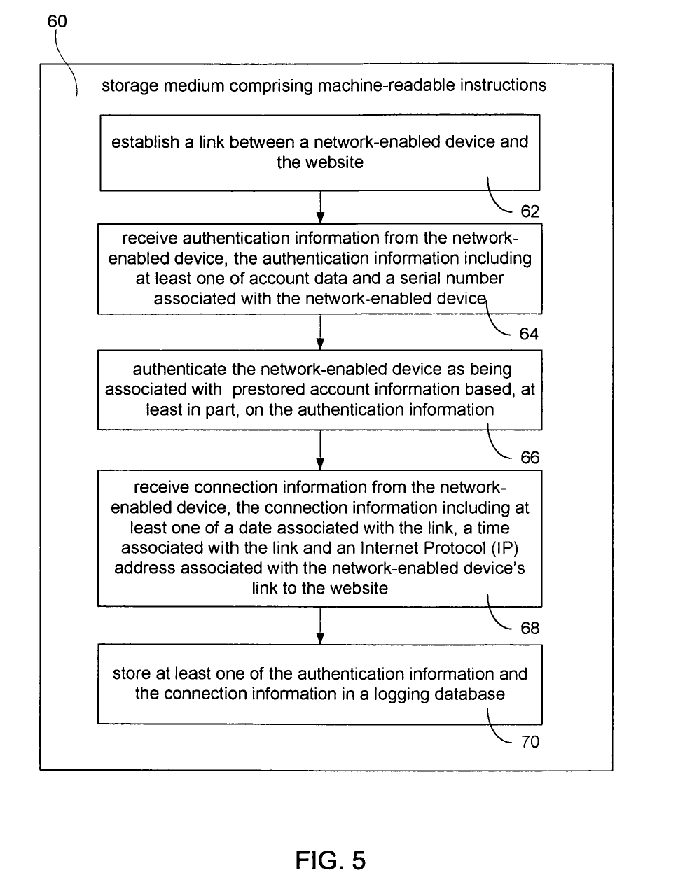

In another exemplary embodiment (as shown in FIG. 5), a storage medium 60 comprising machine-readable instructions stored thereon is provided. The instructions, when executed by one or more processing units, are configured to operatively enable a computing platform to perform operations. The instructions may include establish 62 a link between a network-enabled device and the website, receive 64 authentication information from the network-enabled device, authenticate 66 the network-enabled device as being associated with prestored account information based, at least in part, on the authentication information, receive 68 connection information from the network-enabled device, and store 70 the authentication information and/or the connection information in a logging database. In this embodiment, the authentication information may include account data and/or a serial number associated with the network-enabled device. Further, the connection information may include a date associated with the link, a time associated with the link and/or an Internet Protocol (IP) address associated with the network-enabled device's link to the website. In another embodiment, the storage medium 60 may further include instructions to generate a report associated with the link between the network-enabled device and the website, and transmit the report to an owner of the network-enabled device, a user of the network-enabled device and/or a law enforcement agency. Such a report may include the IP address associated with the network-enabled device's link to the website.

In an exemplary embodiment, the present disclosure considers that a lost or stolen network-enabled device may eventually get assigned and/or use an Internet Protocol (IP) address to access a network (such as the Internet, for example). Due to the vast and rapid expansion of network-enabled devices requiring IP addresses and the fact that the estimated 4 billion IP addresses available under IPv4 are almost all claimed or in use, IPv4's viability is limited. A switch to a more expansive and usable system such as IPv6 128-bit addressing may be needed. In one embodiment, a software application is placed and/or installed on a subscriber's device, either in the BIOS, ROM, EPROM, EEPROM, Flash ROM, the operating system or as an add-on application which accesses a predetermined web address or IPv6 128-bit address and which activates at the start or restart of the device or notebook. The software application may be configured to report the account number and/or public IPv6 128-bit address to be recorded in the database. In the event an IPv6 128-bit network-enabled device is lost or stolen, a user may wait for the device to be issued a private address or a public address for the Internet, then the device will reveal the public IPv6 128-bit address of use regardless of what protocol used. In one embodiment, the software application may be added to existing applications, such as Apple's iTunes application. In that example, Apple's iTunes application would be capable of revealing the public IPv6 128-bit address of use.

In one embodiment, a worldwide database may be located at a central location accessible via the Internet. In this embodiment, a plurality of Internet-enabled devices may have a tracking tool installed thereon. This tracking tool may reside in a setup routine of each device. When the device is issued an IP address to access the Internet, the tracking tool may then communicate with a predetermined website or IPv6 128-bit address. The website may be supplied with an account and/or serial number. The website communicates with an associated database to match the account number and/or serial number to the database. If a match occurs (e.g. if the account number and/or the serial number has been previously provided to the website by a user of the device). The matched information is then recorded, along with the date and time. In addition, the program may store the IPv6 address secured from the Internet transaction. This IPv6 128-bit address may be used to reveal the Internet Service Provider (ISP). Law enforcement (if and when they receive this information) may contact the ISP for the physical address associated with the IPv6 128-bit address captured in the database. They may then ascertain the current location of the device using this physical address, acquire a search warrant, recover the lost or stolen property and take appropriate action (if any) regarding the possessor of the device. Further, in this manner, important data stored on the device may also be recovered.

In yet another embodiment, a method of tracking and/or locating a network-enabled device is provided. This embodiment may include the following operations (not necessarily executed in the following order):

1. The device is powered on or rebooted.

2. The device acquires a dynamic Internet Protocol (IP) address utilizing Dynamic Host Configuration Protocol (DHCP) or a static IP address already assigned from a wired and/or wireless access point or by utilizing an Internet Service Provider's (ISP's) router issuing an IP address.

3. A tracking tool, which resides either in the BIOS, the operating system, or as a standalone or add-on program executed within the operating system, waits for the availability of the IP address.

4. The device (utilizing the tracking tool) communicates with a predetermined website (or IP address) via the Internet.

5. The predetermined website, in turn, requests a connection to a database associated with the predetermined website.

6. The request is received by the database's Internet Service Providers' router.

7. The request is tested against security algorithms for known hacking techniques to prevent malicious requests. Once all security levels have been successfully passed, the request is forwarded to a database server associated with the predetermined website.

8. Upon connection to the database, the tracking tool supplies the database with a serial number, account number or other unique alphanumeric indicia and matches that indicia against an indexed key within the database to ensure that the indicia is a valid indicia to be recorded into the database.

9. The database captures and/or strips the IP address from the internet packet, acquires the date and time from the database server and posts the unique indicia, date, time and IP address to the database as a new record.

10. In the event of a lost or stolen device, a device owner, user, subscriber and/or agent may log on to a report server with the serial number, account number and/or other unique alphanumeric indicia from any network-enabled device.

11. The serial number, account number and/or other unique alphanumeric indicia is then passed to the database's Internet Service Provider's router.

12. The request is accepted through a firewall (if any) and tested against security algorithms for known hacking techniques. Once all security levels have been successfully passed, the request is forwarded to the database server.

13. All relevant data to the keys supplied are then processed and a report containing date, time and IP address is produced with each database record appearing therein.

14. The information provided by the report may be transmitted to and/or used to physically track and/or locate the device either by the user, owner, agent and/or law enforcement agency.

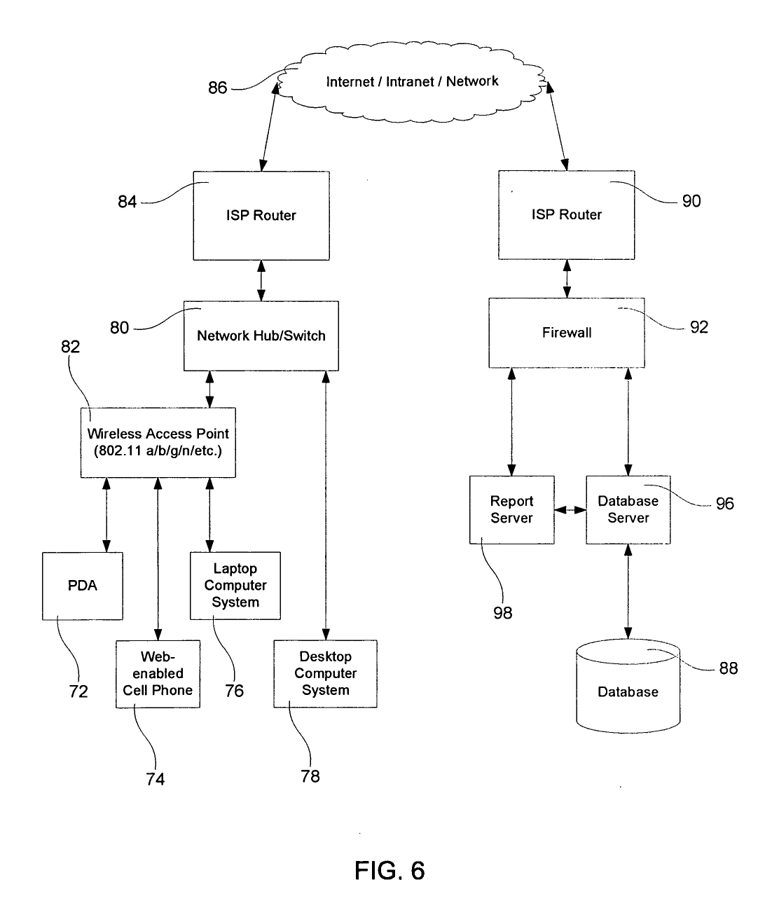

In another exemplary embodiment, a method of tracking and/or locating a network-enabled device is provided. Such an embodiment may be implemented in a system as depicted in FIG. 6, for example. This embodiment may include the following operations (not necessarily executed in the following order):

1. The device (or computer) 72, 74, 76, 78 is powered on or rebooted.

2. The system may allow the user to utilize their own network-enabled device 72, 74, 76, 78 to acquire a dynamic internal IP address utilizing Dynamic Host Configuration Protocol (DHCP), or a static IP address already assigned from one of many wired 80 or wireless access points 82 or by utilizing the Internet Service Providers' router 84 issuing an IPv6 128 bit address.

3. A program, which resides in the BIOS, the operating system, and/or as a standalone program executed within the operating system, then waits for the availability of an IPv6 128-bit address. The internet (or other network) 86 is then utilized to gain access to a predetermined website or IPv6 128-bit address which in turn connects to the database 88.

4. The internet request is received by the database's Internet Service Providers' router 90.

5. The request is accepted through the firewall 92 and tested against security algorithms for known hacking techniques. Once all security levels have been successfully passed, the request is forwarded to the database server 94.

6. Upon connection to the database 88, the program supplies the database 88 with a serial number, account number and/or other unique alphanumeric designator and matches that designator against an indexed key within the database 88 to ensure that the designator is a valid identifier to be recorded into the database 88.

7. The database 88 then captures or strips the IPv6 128-bit address from the internet packet; acquires the date and time from the database server 96 and posts the unique identifier, date, time and IPv6 128-bit address to the database 88 as a new record.

8. In the event of a lost or stolen device, the subscriber and/or agent logs on to the report server 98 with the serial number, account number and/or other unique alphanumeric designator from any network ready device.

9. The serial number, account number and/or other unique alphanumeric designator is then passed to the database's Internet Service Providers' router 90.

10. The request is accepted through the firewall 92 and tested against security algorithms for known hacking techniques. Once all security levels have been successfully passed, the request is forwarded to the database server 96.

11. Relevant data to the keys supplied are then processed and a report containing date, time and IPv6 128-bit address is then produced with each database 88 entry appearing on a unique line.

12. The information provided by the report may then be used to physically locate the device by the owner and/or agent.

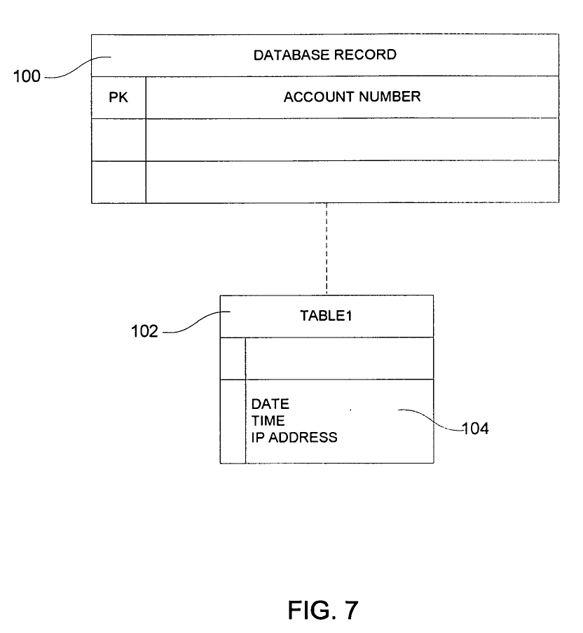

FIG. 7 depicts a database record 100 that may be stored in a database 88 in one embodiment. It should be noted that data may be transmitted to and/or from the database record 100 either directly or as encrypted data. In one embodiment, an account number, serial number and/or any other unique identifier may be matched to the unique key identified in the database record 100. Further, the IP address and a date and time 104 may be included in a table 102 (such as Table1 in FIG. 7) associated with a database record 100. The date and time 104 may be acquired from the database server 96 to limit the amount of unnecessary data transferred over the network 86. In one embodiment, data captured and data gathered may be entered into table1 102. Additionally, data in table1 102 may be added based on the amount of device starts and/or restarts. In such an embodiment, table1 102 may include a plurality of records, where each record includes an IP address, time and date 104.

The present disclosure contemplates that the methods and systems described herein provide for the quick and efficient recovery of electronic devices (and data stored thereon). This may provide user security with minimal intrusion to the user of the device. In one embodiment, the tracking tool may operate without the device user's knowledge.

In one embodiment, a governmental agency (related to and/or including a law enforcement agency) such as the Department of Homeland Security, for example, may utilize the methods and systems described herein to forensically track and/or locate persons known to be potentially harmful. Based on the IP address, the physical location of the network-enabled device at a given point in time may be determined. Over a specific time period, a historical timeline may be created to show where a device was located. In this manner, such governmental agencies may determine the locations where specific events occurred in the past by utilizing these methods and systems.

To provide additional context for various aspects of the present invention, the following discussion is intended to provide a brief, general description of a suitable computing environment in which the various aspects of the invention may be implemented. While one embodiment of the invention relates to the general context of computer-executable instructions that may run on one or more computers, those skilled in the art will recognize that the invention also may be implemented in combination with other program modules and/or as a combination of hardware and software.

Generally, program modules include routines, programs, components, data structures, etc., that perform particular tasks or implement particular abstract data types. Moreover, those skilled in the art will appreciate that aspects of the inventive methods may be practiced with other computer system configurations, including single-processor or multiprocessor computer systems, minicomputers, mainframe computers, as well as personal computers, hand-held wireless computing devices, microprocessor-based or programmable consumer electronics, and the like, each of which can be operatively coupled to one or more associated devices. Aspects of the invention may also be practiced in distributed computing environments where certain tasks are performed by remote processing devices that are linked through a communications network. In a distributed computing environment, program modules may be located in both local and remote memory storage devices.

A computer may include a variety of computer readable media. Computer readable media may be any available media that can be accessed by the computer and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which may be used to store the desired information and which may be accessed by the computer.

An exemplary environment for implementing various aspects of the invention may include a computer that includes a processing unit, a system memory and a system bus. The system bus couples system components including, but not limited to, the system memory to the processing unit. The processing unit may be any of various commercially available processors. Dual microprocessors and other multi processor architectures may also be employed as the processing unit.

The system bus may be any of several types of bus structure that may further interconnect to a memory bus (with or without a memory controller), a peripheral bus, and a local bus using any of a variety of commercially available bus architectures. The system memory may include read only memory (ROM) and/or random access memory (RAM). A basic input/output system (BIOS) is stored in a non-volatile memory such as ROM, EPROM, EEPROM, which BIOS contains the basic routines that help to transfer information between elements within the computer, such as during start-up. The RAM may also include a high-speed RAM such as static RAM for caching data.

The computer may further include an internal hard disk drive (HDD) (e.g., EIDE, SATA), which internal hard disk drive may also be configured for external use in a suitable chassis, a magnetic floppy disk drive (FDD), (e.g., to read from or write to a removable diskette) and an optical disk drive, (e.g., reading a CD-ROM disk or, to read from or write to other high capacity optical media such as the DVD). The hard disk drive, magnetic disk drive and optical disk drive may be connected to the system bus by a hard disk drive interface, a magnetic disk drive interface and an optical drive interface, respectively. The interface for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the invention.

A number of program modules may be stored in the drives and RAM, including an operating system, one or more application programs, other program modules and program data. All or portions of the operating system, applications, modules, and/or data may also be cached in the RAM. It is appreciated that the invention may be implemented with various commercially available operating systems or combinations of operating systems.

It is within the scope of the disclosure that a user may enter commands and information into the computer through one or more wired/wireless input devices, for example, a keyboard and a pointing device, such as a mouse. Other input devices may include a microphone (functioning in association with appropriate language processing/recognition software as know to those of ordinary skill in the technology), an IR remote control, a joystick, a game pad, a stylus pen, or the like. These and other input devices are often connected to the processing unit through an input device interface that is coupled to the system bus, but may be connected by other interfaces, such as a parallel port, an IEEE 1394 serial port, a game port, a USB port, an IR interface, etc.

A display monitor or other type of display device may also be connected to the system bus via an interface, such as a video adapter. In addition to the monitor, a computer may include other peripheral output devices, such as speakers, printers, etc.

The computer may operate in a networked environment using logical connections via wired and/or wireless communications to one or more remote computers. The remote computer(s) may be a workstation, a server computer, a router, a personal computer, a portable computer, a personal digital assistant, a cellular device, a microprocessor-based entertainment appliance, a peer device or other common network node, and may include many or all of the elements described relative to the computer. The logical connections depicted include wired/wireless connectivity to a local area network (LAN) and/or larger networks, for example, a wide area network (WAN). Such LAN and WAN networking environments are commonplace in offices, and companies, and facilitate enterprise-wide computer networks, such as intranets, all of which may connect to a global communications network such as the Internet.

The computer may be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi (such as IEEE 802.11x (a, b, g, n, etc.)) and Bluetooth™ wireless technologies. Thus, the communication may be a predefined structure as with a conventional network or simply an ad hoc communication between at least two devices.

The system may also include one or more server(s). The server(s) may also be hardware and/or software (e.g., threads, processes, computing devices). The servers may house threads to perform transformations by employing aspects of the invention, for example. One possible communication between a client and a server may be in the form of a data packet adapted to be transmitted between two or more computer processes. The data packet may include a cookie and/or associated contextual information, for example. The system may include a communication framework (e.g., a global communication network such as the Internet) that may be employed to facilitate communications between the client(s) and the server(s).

Following from the above description and summaries, it should be apparent to those of ordinary skill in the art that, while the methods and apparatuses herein described constitute exemplary embodiments of the present invention, it is to be understood that the inventions contained herein are not limited to the above precise embodiment and that changes may be made without departing from the scope of the invention. Likewise, it is to be understood that it is not necessary to meet any or all of the identified advantages or objects of the invention disclosed herein in order to fall within the scope of the invention, since inherent and/or unforeseen advantages of the present invention may exist even though they may not have been explicitly discussed herein.

What is claimed is:

1. A method of tracking a network-enabled device, the method comprising:
establishing a link between the network-enabled device and a predetermined network portal via a tracking tool operating on the network-enabled device;
transmitting at least one identifying indicia to at least one database server operably coupled to the predetermined network portal, the identifying indicia including at least one of a device identifier, an account identifier, an address identifier and a serial number identifier;
comparing the at least one identifying indicia to predetermined information stored on the at least one database server to determine if the at least one identifying indicia matches the predetermined information, the predetermined information including information associated with the network-enabled device; and
upon determining that the at least one identifying indicia matches the predetermined information, storing the at least one identifying indicia in a logging database stored on the at least one database server.

2. The method of claim 1, further comprising:
identifying a physical location of the network-enabled device based, at least in part, on the at least one identifying indicia stored in the logging database.

3. The method of claim 2, further comprising:
providing the at least one identifying indicia stored in the logging database to a law enforcement agency.

4. The method of claim 1, wherein the network-enabled device is configured to access at least one of the Internet, an intranet, an extranet, a local area network, a metropolitan area network, a wide area network, a global area network, a wired network, a wireless network and a cellular network.

5. The method of claim 1, wherein the address identifier includes an Internet Protocol address.

6. The method of claim 1, wherein the predetermined network portal includes at least one of a website, a webpage, a database, a widget and a web application.

7. The method of claim 1, wherein storing operation further includes storing at least one of a time and a date associated with the transmitting operation.

8. The method of claim 1,
wherein the tracking tool is implemented in at least one of the network-enabled device's BIOS, read-only memory (ROM), EPROM, EEPROM, flash ROM, operating system, firmware and software; and
wherein the tracking tool is installed on the network-enabled device by at least one of a manufacturer, a distributor, a reseller, a retailer, an owner and a user of the network-enabled device.

9. The method of claim 1, wherein the establishing a link operation occurs automatically upon providing power to the network-enabled device.

10. The method of claim 1, wherein the establishing a link operation occurs automatically upon establishing a network connection by the network-enabled device.

11. The method claim 1, wherein the network-enabled device includes at least one of a computing device, a desktop computer, a notebook computer, a netbook computer, a routing device, a firewall device, a cellular phone device, an audio device, a video device, a gaming device, a multimedia device and a telecommunications device.

12. A method of tracking a computing device operably coupled to the Internet, the computing device including a software tool configured to transmit data to a predetermined website having prestored account information associated with the computing device, the method comprising:
establishing a link between the computing device and the predetermined website via the software tool;
transmitting authentication information to the predetermined website, the authentication information including at least one of account data and a serial number associated with the computing device;
authenticating the computing device as being associated with the prestored account information based, at least in part, on the authentication information;
upon authentication, transmitting connection information to the predetermined website, the connection information including at least one of a date associated with the link, a time associated with the link and an Internet Protocol (IP) address associated with the computing device's link to the predetermined website;
storing at least one of the authentication information and the connection information in a logging database;
generating a report associated with the link between the computing device and the predetermined website, the report including at least the IP address associated with the computing device's link to the predetermined website; and
transmitting the report to at least one of an owner of the computing device, a user of the computing device and a law enforcement agency.

13. The method of claim 12, the method further comprising:
identifying a physical location of the computing device based, at least in part, on the IP address stored in the logging database.

14. The method of claim 12, wherein the report further includes at least one of the authentication information and the connection information.

15. The method of claim 12,
wherein a plurality of links are established between the computing device and the predetermined website, each link being established at a unique instance in time; and
wherein the transmitting authentication information, authenticating, transmitting connection information and storing operations are repeated for each of the plurality of links.

16. The method of claim 12, wherein the transmitting operation is performed at least one of automatically after the generating operation, and upon request of at least one of the owner, the user and the law enforcement agency.

17. An article comprising:
a storage medium comprising machine-readable instructions stored thereon, which, when executed by one or more processing units, operatively enable a network-enabled device to:
establish a link between the network-enabled device and a predetermined website;
transmit authentication information to the predetermined website, the authentication information including at least one of account data and a serial number associated with the network-enabled device; and
upon authentication by the predetermined website, transmit connection information to the predetermined website, the connection information including at least one of a date associated with the link, a time associated with the link and an Internet Protocol (IP) address associated with the computing device's link to the predetermined website.

18. An article comprising:
a storage medium comprising machine-readable instructions stored thereon, which, when executed by one or more processing units, operatively enable a computing platform associated with a website to:
establish a link between a network-enabled device and the website;
receive authentication information from the network-enabled device, the authentication information including at least one of account data and a serial number associated with the network-enabled device;
authenticate the network-enabled device as being associated with prestored account information based, at least in part, on the authentication information;
receive connection information from the network-enabled device, the connection information including at least one of a date associated with the link, a time associated with the link and an Internet Protocol (IP) address associated with the network-enabled device's link to the website; and
store at least one of the authentication information and the connection information in a logging database.

19. The article of claim 18, wherein the machine-readable instructions, when executed by the one or more processing units, further operatively enable a computing platform associated with a website to:
generate a report associated with the link between the network-enabled device and the website.
transmit the report to at least one of an owner of the network-enabled device, a user of the network-enabled device and a law enforcement agency.

20. The article of claim 19, wherein the report includes the IP address associated with the network-enabled device's link to the website.
